(19) United States
(12) Patent Application Publication
(10) Pub. No.: US 2026/0195104 A1
(43) Pub. Date: Jul. 9, 2026

(54) COMPILER FOR FMWARE APPLICATIONS

(71) Applicant: Huawei Technologies Co., Ltd., Shenzhen (CN)

(72) Inventors: Filipe Roseiro Cogo, Kingston (CA); Ahmed E. Hassan, Kingston (CA); Gustavo Ansaldi Oliva, Kingston (CA)

(21) Appl. No.: 19/179,647

(22) Filed: Apr. 15, 2025

Related U.S. Application Data
(60) Provisional application No. 63/743,488, filed on Jan. 9, 2025.

(51) Int. Cl. G06F 8/35

(52) U.S. Cl. CPC G06F 8/35

(57) ABSTRACT

Methods and systems for automatically generating software designed to employ a foundation model. The system acts as a compiler, taking an architecture definition and one or more intents, tests and associated gold labels, and producing a near-optimal configuration of parameters for generating the software. A multi-objective optimization function may be used to score candidates. The candidate evaluation may include combining one of the candidate configurations of the one or more configurable parameters with one or more intents to generate a candidate software instance; performing inferences based on the candidate software instance using a first foundation model and a set of prompt instances to produce a set of results; and evaluating the set of results using a corresponding set of pre-approved results to score the candidate software instance. New candidates may be generated from two or more tested candidates using a second foundation model different from the first foundation model.

### CROSS-REFERENCE TO RELATED APPLICATIONS

The present application claims priority to U.S. Provisional Patent Application No. 63/743,488 filed Jan. 9, 2025, the contents of which are hereby incorporated by reference.

### TECHNICAL FIELD

The present application relates to the automated generation of software and, in particular, software that incorporates or builds upon a foundation model (FM).

### BACKGROUND

The rapid proliferation and adoption of foundation models has led to a corresponding increase in the development of FMware. FMware is a type of software designed to employ an FM in order to achieve particular objectives. FMware typically includes a plurality of FM-related components, such as promptware, which is designed to interface with and initiate inference operations using the FM based on one or more prompts. Much focus has gone into how to engineer prompt templates to improve inference results. FMware often includes other FM-related components, such as agentware.

Creating FMware that is well designed for efficient and accurate operation can be a significant challenge due to the sheer number of possible parameters and variations and the uncertain effect of changing them, particularly in combination. It would be advantageous to improve software development around FMware.

### SUMMARY

In accordance with one aspect, the present application describes a method of automatically generating software to employ a first foundation model. The method may include receiving a software architecture definition containing a plurality of components, wherein the components have one or more configurable parameters, and wherein components include at least one inference component; receiving one or more intents associated with the software architecture definition; for a plurality of candidate configurations, combining one of the candidate configurations of the one or more configurable parameters with the one or more intents to generate a candidate software instance; performing inferences based on the candidate software instance using the first foundation model and a set of prompt instances to produce a set of results; evaluating the set of results using a corresponding set of pre-approved results associated with the prompt instances to score the candidate software instance; and selecting from among a plurality of candidate configurations a best configuration based on the scores to generate software based on the software architecture definition using the best configuration.

In some implementations, the components include a retrieval augmented generation system, and the one or more configurable parameters include text chunking length or embedding model parameters.

In some implementations, the one or more configurable parameters include a prompt, the candidate configurations of the one or more configurable parameters include one or more prompt templates, and combining includes adding at least one of the one or more intents to one of the one or more prompt templates to generate a candidate prompt.

In some implementations, the components include one or more agentware components, and the one or more configurable parameters include configuration of the one or more agentware components. In some cases, the one or more agentware components include at least one router agent, state machine agent, or autonomous agent.

In some implementations, the method further includes mutating the candidate configuration, using a second foundation model different from the first foundation model, to obtain a mutated candidate configuration and repeating the combining, performing and evaluating operations using the mutated candidate configuration. In some cases, the combining, performing, evaluating and mutating are repeated until a stopping condition is met, wherein the stopping condition includes the score exceeding a threshold, a time elapsed, or a number of iterations.

In some implementations, the method further includes, after evaluating, selecting a plurality of candidate configurations associated with the highest scoring candidate software instances, generating an offspring candidate configuration using a cross-over process with the plurality of candidate configurations, and mutating includes mutating the offspring candidate configuration. In some cases, mutating includes instructing the second foundation model to modify the offspring candidate configuration.

In some implementations, the evaluating is based on a multi-objective optimization function, and wherein the multi-objective optimization function includes, as factors to be optimized, prompt length or response time.

In some implementations, the method further includes generating one or more new prompt instances and corresponding pre-approved results using a second foundation model and adding the one or more new prompt instances to the set of prompt instances.

In some implementations, evaluating includes determining a score for the candidate software instance for each prompt instance in the set of prompt instances and aggregating the scores to obtain an aggregated score for the candidate software instance.

In another aspect, the present application describes a system that may include one or more computing devices having one or more processors and memory, the memory storing processor-executable instructions that, when executed by the one or more processors, are to cause the one or more processors to carry out operations of one or more of the methods described herein.

In yet a further aspect, the present application describes a computer-readable medium storing computer-executable instructions that, when executed by one or more processors, are to cause the one or more processors to carry out any one or more of the methods described herein.

In another aspect, the present application describes a computer program comprising instructions which, when executed by a computing device, are to cause the computing device to carry out any one or more of methods described herein.

In a further aspect, the present application describes a computing device having means to perform any one or more of the methods described herein.

Other aspects and features of the present application will be understood by those of ordinary skill in the art from a review of the following description of examples in conjunction with the accompanying figures.

### BRIEF DESCRIPTION OF THE DRAWINGS

Reference will now be made, by way of example, to the accompanying drawings in which:

FIG. 1 illustrates an example FMware module;

FIG. 2 shows a process for automatically generating software designed to employ a first foundation model;

FIG. 3 diagrammatically illustrates a technology stack for automated FMware generation;

FIG. 4 shows, in flowchart form, one example method for automatically generating software that uses a foundation model;

FIG. 5 diagrammatically illustrates the flow of an FMware software compiler process in a simplified example;

FIG. 6 shows a high-level diagram of an example computing device; and

FIG. 7 shows a simplified example of software components within the computing device.

Like reference numerals are used in the drawings to denote like elements and features.

### DETAILED DESCRIPTION OF ILLUSTRATIVE EMBODIMENTS

In recent years, Artificial Intelligence (AI) has experienced an exponential growth, gaining widespread adaption across industries. The advent of transformer-based architectures, an advanced type of deep neural network, has played a crucial role in the expansion and adoption of AI. Large Language Models (LLMs) are a transformer-based model characterized by their significant size and extensive training on vast amounts of text data. Their large size and training make them capable of handling a wide range of natural language processing tasks, including generative operation in which an input prompt, such as a natural language query, causes the model to generate an answer to the prompt. The answer may be in the form of a newly-generated text or image or other media, for example.

Foundation Models (FMs), such as LLMs, can be powerful tools for a variety of tasks. FM-powered software (FMware) will become increasingly prevalent as a fundamental type of software for providing AI-capabilities across a range of contexts. FMware can be simple or complex. Simple FMware may serve as a wrapper or interface to an LLM, for example, such as in the case of ChatGPT. Other FMware may be more complex and may be based around specific intents aimed as particular applications or solutions. FMware in some cases may include retrieval-augmented generation (RAG) to fetch relevant information, continuous data flows powered by a data flywheel approach that provides up-to-date context, and a runtime environment where models are constantly evolving in response to changing inputs, feedback loops, and tasks. Designing, deploying and updating FMware is a significant challenge.

FMware may include one or more of a variety of components. Some components may be classified as “promptware”, which may include the structure and content of prompt templates for example or ancillary systems that may be used in association with prompts, like RAG systems. Some components may be classified as “agentware”, which may use FMs to implement certain types of agents, including autonomous agents capable of decision-making and/or interaction with the environment or with other agents. Some other types of components may include “neuralware”, which is typically a (relatively small) deep learning model.

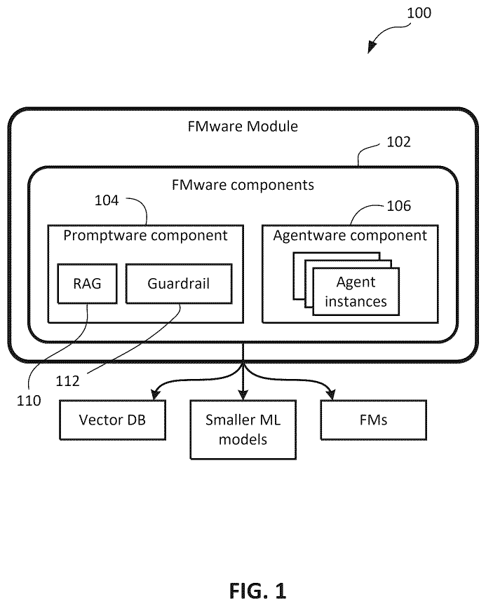

FIG. 1 diagrammatically shows an example FMware module 100. The FMware module may be implemented by way of software instructions stored in memory and that, when executed by one or more processors, cause the processors to carry out the functions of the components of the FMware module 100.

The FMware module 100 may include FMware components 102. In this example, one FMware component 102 is shown; however it will be understood that the FMware module 100 may include multiple FMware components 102. The FMware components 102 may include a promptware component 104 and an agentware component 106. In this example one promptware component 104 and one agentware component 106 are shown for ease of illustration, but it will be appreciated that different implementations may include zero, one or many promptware components 104 and zero, one or many agentware components 106.

The promptware component 104 may include one or more prompt templates, a RAG system 110 or interface to a RAG system, including embedding model(s). It may further include data verification settings or parameters (e.g. guardrails 112).

The agentware component 106 may enable multiple agent instances in some implementations. The agentware component 106 may include fully autonomous agents, capable of planning actions, executing them, and interacting with the environment autonomously. In some cases, the agentware component 106 may include application-specific agents for routing or processing particular data, each having specific data and control flow parameters. The agents may be applied for particular computational functions in some cases.

Each promptware component 104 and agentware component 106 has one or more configurable parameters associated with it. Determining a suitable configuration of these components presents a significant technical challenge. A poor configuration may result in sub-optimal performance and can result in failure to operate in some cases.

Within the specific category of prompt templates, there have been attempts to automate the determination of an optimal prompt.

In accordance with one aspect of the present application, the description below details example embodiments of an FMware compiler, designed to co-optimize different components of FMware to generate an optimal configuration.

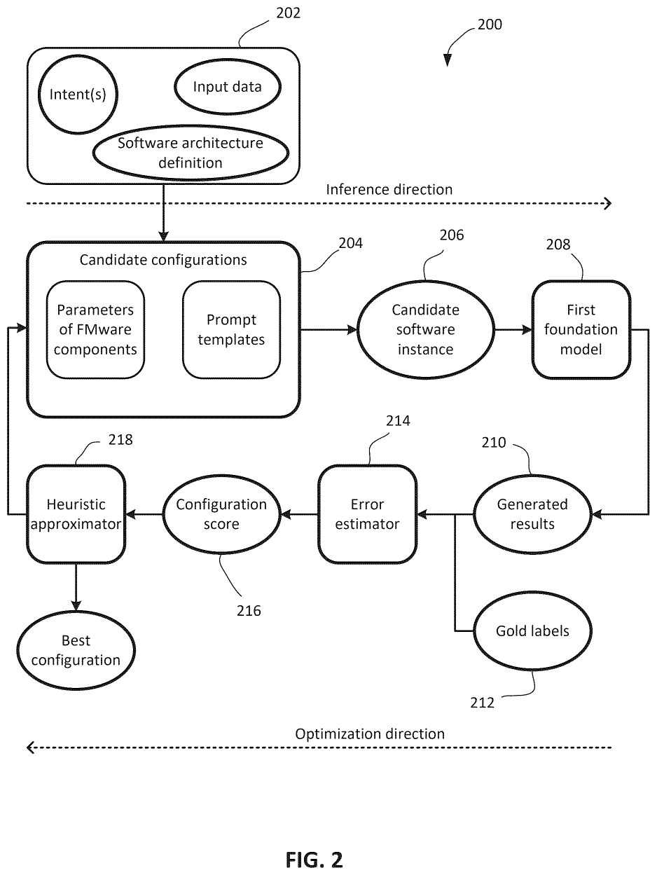

FIG. 2 illustrates a process 200 for automatically generating software designed to employ a first foundation model. The software may be FMware intended to carry out one or more specific operations or tasks. To this end, the inputs 202 to the process 200 may include one or more intents (i.e. functional goals, objectives, or operations that the software is to carry out). The inputs 202 may further include a software architecture definition. The software architecture definition may specify one or more FMware components that will be included in the software. The components may include one or more promptware components and/or one or more agentware components. The inputs 202 may further include additional input data, which may include task-dependent data, instances of data for generating prompts having associated gold labels, or other such data.

The components have one or more configurable parameters. For example, with promptware the prompt template itself may be a configurable parameter. With a RAG system component, the tokenization may be configurable, the embedding model may be configurable. the chunking of the knowledge base may be configurable, the guardrails may be configurable, or some other operational parameter may be configurable. With agentware components, parameters associated with the agents'cognitive architecture (such as the number of agents, the roles of the agents, etc.) may be configurable. Memory parameters, such as memory buffer size, may be configurable. In some cases, the architecture definition specifies a conceptual model but the inclusion or exclusion of certain components, as well as one or more configurable parameters of those components, may be one of the configurable parameters evaluated.

The inputs 202 are combined with a selected one of a set of candidate configurations 204 to generate a candidate software instance 206. For example, a candidate configuration may specify a particular arrangement of a prompt template and/or a particular configuration of a RAG system and/or a particular set of parameters for an agentware component. The candidate software instance 206 is then used in combination a prompt instance and a first foundation model 208 in an inference operation or inference phase. The prompt instance may be a selected one of the prompt templates for that candidate software instance 206 populated by an instance of data from the inputs 202. The candidate software instance 206 may be directed to a particular example prompt-solution, e.g. a prompt instances having an associated pre-approved result or “gold label” or ground truth solution. The first foundation model 208 is the foundation model with which the FMware is intended to eventually be deployed in production. That is, it is the model that will be used in actual operation of the FMware. In some cases, it may be a task-specific model pre-trained for whatever the FMware is designed to achieve. In some cases, this may make it a smaller, more compact model than the foundation model that is used int eh search for candidate software instances, as will be described further below. The first foundation model 208 may be intended for operation on edge devices in some cases.

Testing of the candidate software instance 206 using one or more prompt-solutions, e.g. “tests”, produces a corresponding set of results 210. The set of tests (e.g. prompt instances) have an associated set of gold labels 212, i.e., pre-approved results or answers. This allows the results 210 to be evaluated against the set of gold labels 212 in order to determine the suitability of the candidate configuration in an optimization phase.

An error estimator 214 compares the results 210 with the gold labels 212. The error estimator 214 may be implemented using a same first foundation model 208 in some embodiments. The error estimator 214 may adopt one or more different approaches to calculate a score 216 for the candidate software instance 206, as long as the evaluation is suitable for the task performed by the component under optimization. For example, to compare the generated results 210 against the gold labels 212, a code generation task may use text-based metrics, such as BLEU, or test-based metrics, such as computational accuracy, e..g pass@k. A separate second foundation model may be used in taking those scores 216 and using them, and the candidate configurations 204, to generate new candidate configurations 204, among other tasks. The second foundation model may be, in some cases, a larger, general foundation model operating on one or more cloud servers.

Finally, a heuristic approximator 218 records the best configuration found during the optimization process and applies operations to modify the components'parameters and prompt templates to generate new candidate configurations. The heuristic approximator 218 may be implemented, in part, using the second foundation model. The modifications made by the second foundation model in generating new candidate configurations 204 for evaluation may be aimed at steering the optimization process towards better candidate solutions. The heuristic approximator 218 may use various methods to modify the components'parameters (e.g., random search) and prompt templates (e.g., using the second foundation model to rewrite the template or using differentiable prompt formats such as soft prompts). In some cases, the modifications may include modifying the software architecture definition, e.g. to include or remove components. The optimization process is repeated until a certain stop criterion is achieved, such as the number of iterations, compilation time, or a threshold configuration score.

The software architecture definition for an FMware program may represent each component by an “Operation” that implements an arbitrary functionality and contains both static and dynamic parameters, with some of the dynamic parameters being optimizable. For example, an Operation can represent a promptware component that performs a FM inference, for which a prompt template can be optimized, or retrieval from a vector database (e.g. RAG), for which the parameter associated with the top-k documents can be optimized. All Operation elements may have a common interface that can be used to specify optimizable parameters and an “Optimizer”. An Operation is a stateful entity that exchanges messages with another Operation, being suitable to different FMware program representations, such as prompt chains, computation DAGs, or cognitive architectures.

An Optimizer in this context is a pluggable component that specifies how the parameters of an Operation are optimized. For instance, an example optimizer may use an NSGA-II multi-objective genetic algorithm (GA) to optimize prompt templates, allowing the customization of all genetic operators such as crossover, and mutation in addition to the objective functions. This prompt template optimizer may use a FM (e.g., the second foundation model) to drive the search (e.g., to mutate a prompt candidate) and may receive as parameters the associated intent with the Operation (e.g., “generate source code from documentation”), input data (e.g., the function signature and documentation), the tests and gold labels (e.g., unit tests), and/or references to both the evaluator-and release-FMs used to drive the search and evaluate the candidate results, respectively. An Optimizer can be extended or customized according to the task performed by the associated Operation. For instance, for the optimization of enumerable component parameters, a GA-based optimizer may use some genetic representation of the parameters (e.g., an array of binaries for integers and floats), avoiding the high costs of using a FM to drive the search.

An Optimizer may also have an aggregation relationship with other components of the optimization phase, such as a component defining the format and evaluation logic of the gold labels used during the optimization phase. Gold labels may be highly dependent on the task performed by the associated Operation with an Optimizer.

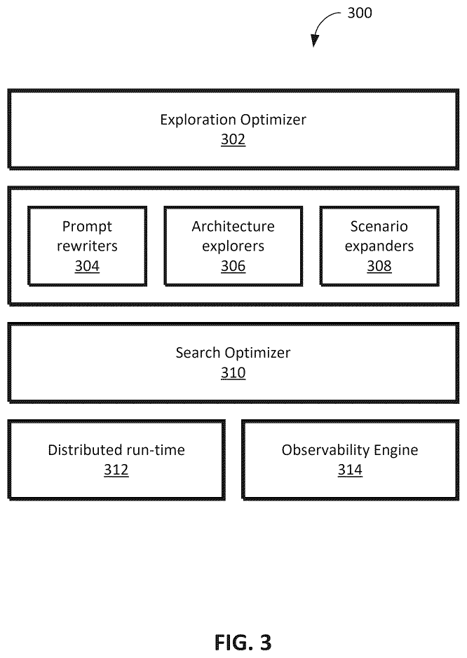

FIG. 3 diagrammatically illustrates a technology stack 300 for automated FMware generation, e.g. an FMware compiler.

The stack 300 in this example includes exploration optimizers 302, prompt rewriters 304, architecture explorers 306, scenario expanders 308, a search optimizer 310, a distributed synthesizer run-time 312, and an observability engine 314.

The exploration optimizers 302 drive the search processing using techniques like self-reflection. An optimizer may use a variety of optimization objectives and may be configured to use more than one objective. Example objectives include accuracy, response time, prompt length, computational cost, or other such factors.

The prompt rewriters 304 focus on refining prompt templates to obtain better outcomes. The prompt rewriters 304 may utilize one or more prompt engineering techniques. Various prompt engineering techniques may be provided in a library from which the prompt rewriters 304 may select to implement one or more techniques for refining a prompt.

The architecture explorers 306 search for optimal configurations of RAG parameters and patterns of cognitive architectures, such as FM Call (a basic architecture focusing on single function model calls), FM Chain (a sequential model chain, where outputs of one model feed into the next), Router Agent (an architecture where an agent routes tasks based on the context or input type), State Machine Agent (a structured architecture that operates based on predefined states and transitions), and Autonomous Agents (fully autonomous agents that make decisions and act independently within the system).

The scenario expanders 308 synthesize new tests and associated gold labels with which to test candidate software instances to evaluate candidate configurations. The existing set of tests and gold labels may be inputs to a FM prompt that guides the FM to generate a new test and gold label that expands upon the domains and scenarios. The scenario expansion may assist in ensuring that the optimization search targets different domains using a diverse set of scenarios.

The search optimizer 310 may leverage prior local and/or crowd-runs for more efficient driving of the search process. In particular, it may use the compilation traces of prior compilations as feedback information and it may reuses them to make the next compilation more efficient (e.g., caching common compilation steps). Past search data may further help in tuning the parameters of search algorithms (like genetic algorithms, simulated annealing, etc.) to better fit the problem space based on previous outcomes. Insights from past searches may also guide the development of new heuristics that are more adept at solving specific types of problems, thereby improving search efficacy. Historical searches can also be used to understand user preferences, allowing for personalization. By continuously incorporating insights gained from historical search data, the system may incrementally improve.

The distributed synthesizer run-time 312 uses a distributed platform to speed up synthesis. This is the run-time that drives the compiler and its optimization may be aimed at speeding up the optimization processes. A separate run-time environment for the software instance may have its own optimizations aimed at executing the FMware solution efficiently.

The synthesizer observability engine 314 may enable debugging and traceability of the synthesizer, thereby enabling developers to understand program states that caused issues and to take action, if needed. Debugging and traceability may be needed at several levels of abstraction (e.g., cognitive architecture selection, optimizations within a given cognitive architecture, prompt optimizations).

Other elements of the stack 300 may include an AI-native developer environment, and infrastructure that supports the FMware implementation, such as knowledge infrastructure for RAG systems, multi-agent infrastructure to drive autonomous agents, and data alignment infrastructure to support FM alignment (e.g., fine-tuning).

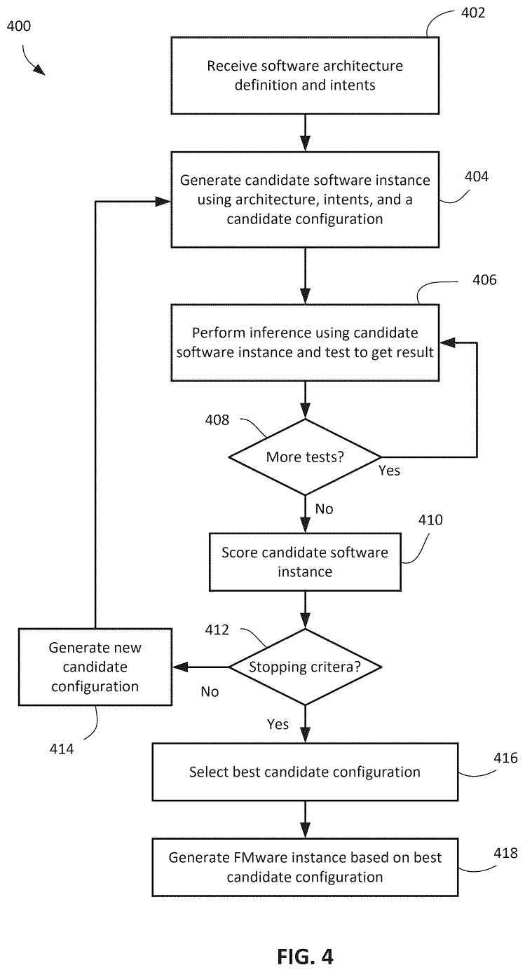

Reference will now be made to FIG. 4, which shows, in flowchart form, one example method 400 for automatically generating software that uses a foundation model. The software includes one or more FMware components, such as promptware and/or agentware. The method 400 may be implemented by way of software instructions executed by one or more processors as part of one or more computing devices. The one or more computing devices may communicate over a network connection and one or more of the devices may include cloud servers. In some cases, the method 400 is implemented, wholly or partly, within a software development platform, e.g. an integrated development environment.

In operation 402, the platform receives a software architecture definition and one or more intents. It may further receive additional input data, as noted above. In one implementation, the software architecture definition may be specified in terms of Operations and Optimizations, as discussed above. That is, the architecture definition may specify one or more components, such as promptware and/or agentware, along with its objective or function and the one or more configurable parameters associated with that component. The one or more intents may specify the functional requirements of the software that indicate the objective or goal of the FMware.

In operation 404, the platform generates a candidate software instance. The candidate software instance may be generated by combining the architecture definition and intents with a candidate configuration. The candidate configuration may be one specific setting of the one or more configurable parameters. In some examples, the candidate configuration may include a specific phrasing or structure of a prompt template into which intents are inserted. The candidate configuration may be a specific embedding operation, a parameter associated with a RAG operation, a guardrail parameter, a memory buffer size, a number of autonomous agents, an agent type or role, or other such settings of configurable parameters.

The candidate software instance is an instance of the FMware based on the architecture definition and the candidate configuration. In operations 406 and 408, the platform tests the candidate software instance by performing inference using a set of one or more tests and their associated gold labels. The tests and associated gold labels may include requests and expected results. The nature of the requests depend on the nature of the FMware and its intended use. An initial set of tests and gold labels may be provided by a developer based on the intents of the FMware, and subsequent tests may be developed automatically using a generative FM, as described herein. The inference of operation 406 includes executing the candidate software instance with one of the tests to produce a result. The candidate software instance uses a first foundation model, which is the foundation model intended for use in production release of the software. As noted above, the first foundation model may be specific pre-trained model tailored for use in the FMware. In some cases, one of the configurable parameters may include a speed parameter that constrains operation of the candidate software instance so as to ensure a result is output within a predetermined time frame.

In operation 410, the platform scores the candidate software instance. In one implementation, the scoring may be based on a comparison of test results to gold labels and a distance calculation for determining accuracy of the results. In some cases, the scoring employs a foundation model to evaluate the test results based on the gold labels. The model may be provided with one or more objectives for assessing optimization, which may form part of the intents or the software architecture definition received in operation 402 in some cases. The optimization objectives may include one or a combination of speed of operation, computational cost, memory usage minimization, accuracy/relevance, or other such objectives. In some cases, the intents and/or architecture may specify a weighting and/or hierarchy of objectives. A second foundation model different from the first foundation model may be used in the scoring or evaluation operation.

In operation 412, the platform evaluates whether a stopping condition has been reached. Example stopping conditions may include the score having reached a stopping criteria or threshold, having tested a predetermined maximum number of candidate configurations, a time threshold (e.g. running the method 400 for up to a maximum amount of time), or other such conditions.

If the stopping condition has not been reached, then in operation 414 the platform generates a new candidate configuration. In some cases, as will be described in more detail below, the platform may generate a new candidate configuration based on one or more tested candidate configurations by mutating or altering that configuration (or those configurations). In some cases, this includes generating an offspring candidate configuration from one or more tested configurations. In some cases, the offspring candidate configuration may further be mutated to create the new candidate configuration. A second foundation model or a third foundation model may be used in generating the new candidate configuration. In some cases, the model may be provided with one or more tested configurations and an instruction to generate the new candidate configuration. The model may further be provided with the score(s) associated with the tested configurations.

Once the new candidate configuration is generated, it is fed back to repeat the operations of generating a software instance and testing and scoring it through the inference phase and evaluation phase. If the stopping condition is reached in operation 412, then in operation 416 the platform selected the best candidate configuration, e.g. the highest scored configuration. In operation 418, the platform may generate and output an FMware software instance based on the best configuration selected in operation 416.

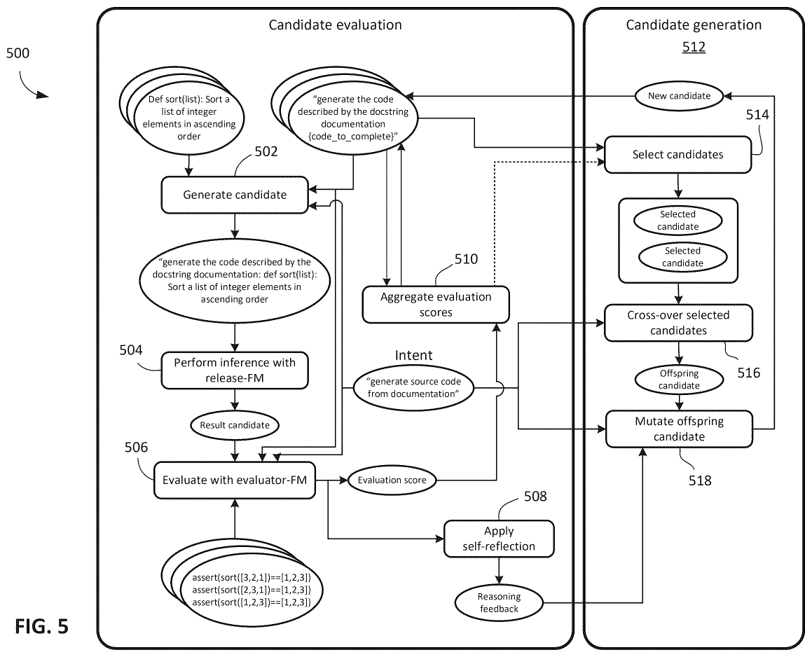

Reference will now be made to FIG. 5, which diagrammatically illustrates the flow of an FMware software compiler process 500 in a simplified example. In this simplified example, the FMware is designed to include a single promptware component. It will be appreciated that the present application presumes most implementation will involve optimization of FMware that includes two or more components. An input to the process 500 may be a document containing a description of the function or objective of the software, e.g. one or more intents for the software. The document or another input may further specify the architecture for the software. In some cases, this may include one or more function signatures specifying the one or more components. In some cases, one or more intents may be associated with each of the components or functions. The complier process 500 then uses the description and the one or more components each having one or more configurable parameters, to determine a near-optimal configuration for the software.

In this simplified example, the component may be a promptware component where the configurable parameter is the prompt template. The description or objective associated with the FMware in this simplified example is the sorting of a list of integers in ascending order. An initial set of prompt templates may be provided by a developer with the other inputs or may be determined by the compiler using a generative FM. The developer may further provide a set of tests and gold labels, i.e. sets of example integers and results in which they are correctly sorted. It will be appreciated that this is a trivially simple example of code generation, but it will help illustrate the flow of the complier process 500.

In operation 502, the compiler process 500 generates a candidate prompt instance through combining a candidate prompt template with the intent, e.g. with the description of the function or objective of the software, and a prompt instance, e.g. a prompt problem or test instance, which in this example is to “sort a list of integer elements in ascending order”. In a more complex example, the prompt template may have a number of fields or placeholders that are replaced by one or more parts of the description of the function or objective of the software reflecting the intents. In this simplified example, the placeholder {code_to_complete} of a prompt template is replaced by a function signature with a documentation string. During the optimization process, the contents assigned to the placeholders remain static, while the template's other components (e.g., few-shot examples or instructions) are subject to optimization. In addition, each component of the template can be optimized separately. Other promptware and agentware components undergo this step by binding static arguments to the non-optimizable parameters while pre-defining initial states for the optimizable parameters.

The candidate prompt instance together with the promptware component are effectively a candidate FMware software instance in this example. The candidate under evaluation is the completed code, which concatenates the function signature and documentation string provided as a problem instance with the generated result by a foundation model. In this step, the release-FM is used to perform inference, as the prompt template is optimized to the FM used in the deployed FMware application. The candidate instance is used in operation 504 to generate results. The candidate instance implements a prompt instance, i.e. it is configured to address a particular prompt instance of a prompt-solution pair that has associated gold-label results. Operation 504 carries out inference using the first foundation model and the candidate instance. The first foundation model is the model intended for use by the software at deployment.

In operation 506, the results are compared with their associated gold labels to evaluate the instance. In this example, to metrics may be used as multi-objective functions: (1) computational accuracy of the code, i.e. the proportion of gold labels that are determined a true positive (correctly sorted), and (2) the time taken to generate all the tokens during inference. It will be appreciated that this is one potential multi-objective function. Other examples may include different objectives, fewer objectives, or more objectives. For instance, an additional objective may be to minimize code complexity. The evaluation operation may employ the first foundation model to assess accuracy of the instance in some cases. In some cases, a second foundation model may be used.

In some implementations, the process 500 may include a self-reflection stage 508 to generate reasoning feedback about how the candidate prompt template should be changed to improve the downstream task described by the intent when the result does not match the gold label of a test. The second foundation model may be used for the self-reflection operation.

In operation 510, the score associated with a candidate instance is determined based on the scores of each of the tests run with that candidate instance. That is, same prompt template may be evaluated against n different test cases. The score calculated for each prompt template is determined based on the results from all the test cases. In this example, the score is found by aggregating the individual test scores. Other methods of combining the scores, such as averaging, weighted averaging, etc., may be used in other implementations.

A candidate generation process 512 aims to generate new candidate configurations, in this case new candidate prompt templates, based on the scores and results from the candidate evaluation process. The second foundation model is used in the candidate generation process 512. In operation 514, an optimizer, e.g. NSGA-II, selects two or more prompt templates from the set of candidate prompt templates. The selection may be based on the scoring performed in operation 510 across a plurality of candidate instances. In one implementation, the selection may be based on crowding distance to select more dispersed individuals in the Pareto-front. In other implementations, other selection processes or algorithms may be used. For example, a roulette-based approach may be used to foster diversity when exploring the solution space. In some cases, more than two templates may be selected in operation 514.

In some implementations, the selected templates may undergo a cross-over process in operation 516. The cross-over process may generate an offspring template. The cross-over process in some cases may include instructing a foundation model to combine the selected templates to generated a new candidate template given the intent. As a customizable operator, the cross-over process may alternatively adopt lower-cost approaches that do not involve FM inference or may even be skipped in some implementations. If skipped, then the selection process may include selecting one template that is then used in the mutation operation described below.

In operation 518, the offspring template (or selected template if no cross-over process is performed) is mutated to introduce one or more variations to the candidate. Mutation may involve instructing a foundation model to modify the offspring prompt template based on the provided intent. The mutation and offspring generation processes may be implemented using one combined instruction to a foundation model in some cases. It may also be possible to combine FM inference with cross-over processes that use simpler token replacement strategies.

The mutated candidate prompt template is then added to the set of candidate prompt templates.

The process 500 may continue until a stopping criteria is reached. As noted above, the stopping criteria may include one or more of a threshold minimum score being achieved, a computation time maximum being reached, a maximum number of iterations being reached, or some other such criteria.

To improve overall compilation time and reduce costs, all calls to the foundation models may be cached, and each iteration of the inner loop of candidate evaluation and generation may be checkpointed. The compiler software may also leverage parallelization opportunities by optimizing candidate results in parallel.

It will be appreciated that the above example, is a simplified one involving the optimization of a prompt template in the case of FMware having a single promptware component.

To optimize other FMware components, operation 502 is adapted. Instead of instantiating a prompt template, the operation my include instantiating the component under optimization. For example, if the component under optimization is a RAG operation, then operation 502 may instantiate this operation with a certain combination of the text chunking length and the embedding model related parameters, where the text chunking length and embedding model parameters are the customizable parameters. Similarly, if the component under optimization is a cognitive architecture, operation 502 may instantiate a cognitive architecture with a certain number of components and dependencies between the components.

Other operations may also be adaptive to optimization of other components. For example, the mutation operation 518 in the case of a RAG component may be configured to modify the associated customizable parameters with that operation (i.e., the same parameters used for the instantiation of the operation), such as selecting another text chunking text chunking length or embedding model. For a cognitive architecture, the mutation operation 518 may rearrange the number of components or the dependencies between the existing components. The cross-over operation 516 may be similarly adapted to modification of such components to generate suitable offspring candidates.

Finally, the process 500 may be used to implement different search strategies. For example, a “gradient descent” like search may be implemented by a cross-over operator that forwards one of the two selected candidates to a mutator operator that, in turn, modifies the optimizing template according to the self-reflection feedback. Similarly, the process 500 may be used to simply evaluate a set of prompt template alternatives and select the best one for a specific intent, generating reasoning traces of how the prompts can be improved.

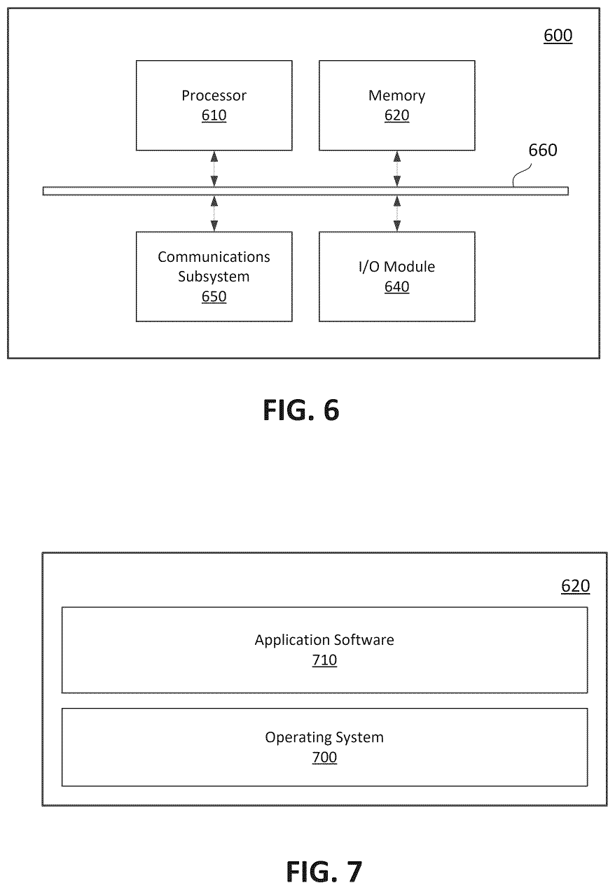

Reference will now be made to FIG. 6, which shows a high-level diagram of an example computing device 600. The example computing device 600 includes a variety of modules. For example, the example computing device 600 may include a processor 610, a memory 620, an I/O module 640, and a communications module 650. As illustrated, the foregoing example modules of the example computing device 600 are in communication over a bus 660.

The processor 610 in this example is a hardware processor. The processor 610 may, for example, be one or more ARM, Intel x86, PowerPC processors, or the like.

The memory 620 allows data to be stored and retrieved. The memory 620 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 600.

The I/O module 640 allows the example computing device 600 to receive input signals and to transmit output signal. Input signals may, for example, correspond to input received from a user. Some output signals may, for example, allow provision of output to a user. The I/O module 640 may serve to interconnect the example computing device 600 with one or more input devices. Input devices may, for example, include one or more of a touchscreen input, keyboard, trackball or the like. The I/O module 640 may serve to interconnect the example computing device 600 with one or more output devices. Output devices may include, for example, one or more display screens such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers.

The communications module 650 allows the example computing device 600 to communicate with other electronic devices and/or various communications networks. For example, the communications module 650 may allow the example computing device 600 to send or receive communications signals. As an example, the communication module 650 may include a network connection, data port, or the like. Communications signals may be sent or received according to one or more protocols or according to one or more standards. For example, the communications module 650 may allow the example computing device 600 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 650 may allow the example computing device 600 to communicate using near-field communication (NFC), via Wi-Fi (TM), via the Ethernet family of network protocols, using Bluetooth (TM) or via some combination of one or more networks or protocols. In some embodiments, all or a portion of the communications module 650 may be integrated into a component of the example computing device 600. In some examples, the communications module may be integrated into a communications chipset.

Software instructions are executed by the processor 610 from a computer-readable medium. For example, software may be loaded into random-access memory from persistent storage within memory 620. Additionally, or alternatively, instructions may be executed by the processor 610 directly from read-only memory of the memory 620.

FIG. 7 depicts a simplified organization of software components stored in memory 620 of the example computing device 600. As illustrated, these software components include, at least, application software 710 and an operating system 700.

The application software 710 adapts the example computing device 600, in combination with the operating system 700, to operate as a device performing a particular function. While a single application software 710 is illustrated in FIG. 7, in operation, the memory 620 may include more than one application software and different application software may perform different operations.

The operating system 700 is software. The operating system 700 allows the application software 710 to access the processor 610, the memory 620, the I/O module 640, and the communications module 650. The operating system 700 may, for example, be iOS™, Android™, Linux™, Microsoft Windows™, or the like.

The application software 710 and/or operating system 700 may, when executed, cause the processor 610 to carry out operations to implement at least some portion of one or more of the methods described herein.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of... or...” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A method of automatically generating software to employ a first foundation model, the method comprising:
receiving a software architecture definition containing a plurality of components, wherein the components have one or more configurable parameters, and wherein components include at least one inference component;
receiving one or more intents associated with the software architecture definition;
for a plurality of candidate configurations,
combining one of the candidate configurations of the one or more configurable parameters with the one or more intents to generate a candidate software instance;
performing inferences based on the candidate software instance using the first foundation model and a set of prompt instances to produce a set of results;
evaluating the set of results using a corresponding set of pre-approved results associated with the prompt instances to score the candidate software instance; and
selecting from among a plurality of candidate configurations a best configuration based on the scores to generate software based on the software architecture definition using the best configuration.

2. The method of claim 1, wherein the components include a retrieval augmented generation system, and wherein the one or more configurable parameters include text chunking length or embedding model parameters.

3. The method of claim 1, wherein the one or more configurable parameters include a prompt, wherein the candidate configurations of the one or more configurable parameters include one or more prompt templates, and wherein combining includes adding at least one of the one or more intents to one of the one or more prompt templates to generate a candidate prompt.

4. The method of claim 1, wherein the components include one or more agentware components, and wherein the one or more configurable parameters include configuration of the one or more agentware components.

5. The method of claim 4, wherein the one or more agentware components include at least one router agent, state machine agent, or autonomous agent.

6. The method of claim 1, further comprising mutating the candidate configuration, using a second foundation model different from the first foundation model, to obtain a mutated candidate configuration and repeating the combining, performing and evaluating operations using the mutated candidate configuration.

7. The method of claim 6, wherein the combining, performing, evaluating and mutating are repeated until a stopping condition is met, wherein the stopping condition includes the score exceeding a threshold, a time elapsed, or a number of iterations.

8. The method of claim 6, further including, after evaluating, selecting a plurality of candidate configurations associated with the highest scoring candidate software instances, generating an offspring candidate configuration using a cross-over process with the plurality of candidate configurations, and wherein mutating includes mutating the offspring candidate configuration.

9. The method of claim 8, wherein mutating includes instructing the second foundation model to modify the offspring candidate configuration.

10. The method of claim 1, wherein the evaluating is based on a multi-objective optimization function, and wherein the multi-objective optimization function includes, as factors to be optimized, prompt length or response time.

11. The method of claim 1, further comprising generating one or more new prompt instances and corresponding pre-approved results using a second foundation model and adding the one or more new prompt instances to the set of prompt instances.

12. The method of claim 1, wherein evaluating includes determining a score for the candidate software instance for each prompt instance in the set of prompt instances and aggregating the scores to obtain an aggregated score for the candidate software instance.

13. A system for automatically generating software to employ a first foundation model, the system comprising:
one or more computing devices having one or more processors and memory, the memory storing processor-executable instructions that, when executed by the one or more processors, are to cause the one or more processors to:
receive a software architecture definition containing a plurality of components, wherein the components have one or more configurable parameters, and wherein components include at least one inference component;
receive one or more intents associated with the software architecture definition;
for a plurality of candidate configurations, combine one of the candidate configurations of the one or more configurable parameters with the one or more intents to generate a candidate software instance;
perform inferences based on the candidate software instance using the first foundation model and a set of prompt instances to produce a set of results;
evaluate the set of results using a corresponding set of pre-approved results associated with the prompt instances to score the candidate software instance; and
select from among a plurality of candidate configurations a best configuration based on the scores to generate software based on the software architecture definition using the best configuration.

14. The system of claim 13, wherein the components include a retrieval augmented generation system, and wherein the one or more configurable parameters include text chunking length or embedding model parameters.

15. The system of claim 13, wherein the one or more configurable parameters include a prompt, wherein the candidate configurations of the one or more configurable parameters include one or more prompt templates, and wherein the instructions, when executed, are to cause the one or more processors to combine by adding at least one of the one or more intents to one of the one or more prompt templates to generate a candidate prompt.

16. The system of claim 13, wherein the components include one or more agentware components, and wherein the one or more configurable parameters include configuration of the one or more agentware components.

17. The system of claim 13, wherein the instructions, when executed, are to further cause the one or more processors to mutate the candidate configuration, using a second foundation model different from the first foundation model, to obtain a mutated candidate configuration and to repeat the combining, performing and evaluating operations using the mutated candidate configuration.

18. The system of claim 17, wherein the instructions, when executed, are to further cause the one or more processors to, after evaluating, select a plurality of candidate configurations associated with the highest scoring candidate software instances, generating an offspring candidate configuration using a cross-over process with the plurality of candidate configurations, and wherein mutating includes mutating the offspring candidate configuration.

18. The system of claim 13, wherein the evaluating is based on a multi-objective optimization function, and wherein the multi-objective optimization function includes, as factors to be optimized, prompt length or response time.

19. A non-transitory computer readable medium storing processor-executable instructions for automatically generating software to employ a first foundation model, wherein the instructions, when executed by one or more processors, are to cause the one or more processors to:
receive a software architecture definition containing a plurality of components, wherein the components have one or more configurable parameters, and wherein components include at least one inference component;
receive one or more intents associated with the software architecture definition;
for a plurality of candidate configurations, combine one of the candidate configurations of the one or more configurable parameters with the one or more intents to generate a candidate software instance;
perform inferences based on the candidate software instance using the first foundation model and a set of prompt instances to produce a set of results;
evaluate the set of results using a corresponding set of pre-approved results associated with the prompt instances to score the candidate software instance; and
select from among a plurality of candidate configurations a best configuration based on the scores to generate software based on the software architecture definition using the best configuration.
